(19) United States
(12) Patent Application Publication
(10) Pub. No.: US 2009/0284545 A1
(43) Pub. Date: Nov. 19, 2009

(54) DISPLAY APPARATUS, DISPLAY CONTROL METHOD, AND DISPLAY CONTROL PROGRAM

(76) Inventors: Hidekazu WATANABE, Tokyo (JP); Hideki YUKITOMO, Kanagawa (JP); Yasuhito KADOWAKI, Tokyo (JP)

Correspondence Address: FROMMER LAWRENCE & HAUG LLP, 745 FIFTH AVENUE, NEW YORK, NY, 10151, US

(21) Appl. No.: 12/467,515

(22) Filed: May 18, 2009

(30) Foreign Application Priority Data
May 19, 2008 (JP) P2008-130437
Aug. 11, 2008 (JP) P2008-206683

(51) Int. Cl. G09G 5/02; G09G 3/36; G09G 5/10

(52) U.S. Cl. 345/589; 345/102; 345/690

(57) ABSTRACT

A display apparatus includes a liquid crystal display element, a backlight, and a plurality of circuits conducting the following. A drive signal for driving the backlight is formed according to an adjustment value calculated from the one-screen average image luminance in the image signal for display and a predetermined linear luminance adjustment curve. An image signal amplification control is then conducted according to a linear image luminance correction curve specified by the adjustment value, the average luminance, and one or both of the one-screen minimum and maximum luminance values detected from the image signal. The corrected image is then supplied to the liquid crystal display element. In so doing, reduced power consumption is realized in the backlight of a liquid crystal display element while maintaining the image quality of displayed images.

### BACKGROUND OF THE INVENTION

1. Field of the Invention

The present invention relates to a display apparatus installed in a compact electronic device such as a mobile phone handset, for example, as well as to a control method and control program used in such a display apparatus.

2. Description of the Related Art

LCDs (Liquid Crystal Displays) have come into widespread use as display elements. Since the liquid crystals themselves are not self-emitting, a backlight is usually provided in order to display images.

CCFLs (Cold Cathode Fluorescent Lamps) are primarily used as backlights for the relatively large LCDs used in devices such as televisions. However, the power consumption in the lighting circuitry of CCFLs is large.

For this reason, there is demand for a backlight featuring reduced size, weight, and power consumption for use with an LCD installed in a compact electronic device such as a mobile phone handset. Furthermore, white LEDs having relatively low power consumption have recently come into use as backlights for LCDs (Liquid Crystal Displays) used as the display elements of PDAs (Personal Digital Assistants).

However, in order to maintain the image quality of images displayed on an LCD, at least a certain amount of current is made to flow in the white LED used as the backlight to brighten the LCD. The power consumption of the backlight LED in the PDA is large as a result.

For this reason, a large number of inventions related to reducing the power consumption of LCD backlights have been developed since the introduction of CCFLs for use as backlights.

For example, Japanese Unexamined Patent Application Publication No. H11-109317 discloses an invention that uses an average picture level (APL) expressing the average luminance of an image as a basis for controlling backlight luminance using a pulse width modulation (PWM) signal, as well as for conducting image correction (i.e., image signal amplification).

More specifically, the invention disclosed in JP-A-H11-109317 first uses the APL as a basis for detecting a somewhat dark image whose signal luminance is not more than an average value, as shown in FIG. 5A, for example. Subsequently, the backlight is dimmed for the somewhat dark image thus detected. At the same time, the image signal (or video signal) forming the somewhat dark image is amplified to the extent that the backlight was dimmed, as shown in FIG. 5B.

Operating as described above, the invention disclosed in JP-A-H11-109317 is able to reduce backlight power consumption by performing a backlight level control (i.e., a dimming control) in accordance with the signal luminance. Moreover, a bright image is obtained by amplifying the image signal to the extent that the backlight is dimmed, thereby maintaining the same degree of image visibility as that existing before the backlight dimming.

### SUMMARY OF THE INVENTION

The above invention disclosed in JP-A-H11-109317 is an effective technology in that reduced power consumption is realized for an LCD backlight without compromising displayed images. However, it has come to be understood that the above technology might not function effectively in some cases, depending on the properties of the image.

To explain in further detail: a given image for display that is made up of an image signal might be dark overall, but in many cases will also contain extremely bright (i.e., high luminance) image portions. It has been empirically confirmed that if the image signal is simply amplified to the extent that the backlight is dimmed for such images, then the image displayed by the amplified image signal might appear unnatural.

For example, as shown in FIG. 6A, it is conceivable that an image signal may be processed wherein the image luminance is low overall, but wherein a high-luminance image portion exists in the center of the screen. When displaying the image made up of the image signal shown in FIG. 6A on an LCD screen, the backlight is dimmed, and the image signal is amplified to the extent of the dimming.

In so doing, the high-luminance portion indicated by the arrow in FIG. 6B is clipped at a signal luminance of 100%. In this case, the signal variance in the high-luminance portion (i.e., the portion of the image signal indicated by the broken lines above the 100% signal luminance level) is lost, and the image signal becomes distorted. Consequently, in such cases, there is a high probability that a natural image will not be displayed.

Furthermore, normal video usually contains few images wherein the luminance of the overall image is uniformly low, instead containing many images that are bright in portions even if dark overall. For this reason, if steps are taken to prevent distortion of the displayed images, then it is conceivable that the amount of headroom for actually dimming the backlight in the image signal to be processed (i.e., the amount by which the power provided to the backlight can be lowered) will be almost wholly eliminated.

Devised in light of the foregoing, the present invention provides technology whereby reduced power consumption in the backlight of a liquid crystal display element is realized without being dependent on the characteristics of the image signal to be processed, and additionally whereby the display image can be suitably displayed.

A display apparatus in accordance with a first embodiment of the present invention that solves the foregoing problems is provided with: a liquid crystal display element; backlight means for use with the liquid crystal display element; average luminance calculating means for calculating the one-screen average luminance of an image expressed by an image signal for display; adjustment value calculating means for calculating an adjustment value used to adjust the luminance of the backlight means on the basis of the one-screen average image luminance from the average luminance calculating means, as well as a predetermined linear luminance adjustment curve; drive signal forming means for forming a drive signal used to cause the backlight means to emit light on the basis of the adjustment value calculated by the adjustment value calculating means, and then providing the resulting drive signal to the backlight means; luminance information detecting means for detecting one or both of the one-screen minimum image luminance and the one-screen maximum image luminance in the image signal for display; and image correcting means for conducting an amplification control with respect to the image signal for display on the basis of a linear image luminance correction curve specified by the adjustment value calculated by the adjustment value calculating means, the average luminance calculated by the average luminance calculating means, and one or both of the minimum luminance and the maximum luminance detected by the luminance information detecting means, and then providing the corrected image signal to the liquid crystal display element.

According to the display apparatus in accordance with a first embodiment of the present invention, adjustment value calculating means uses the one-screen average image luminance calculated by average luminance calculating means, as well as a predetermined linear luminance adjustment curve, to calculate an adjustment value used to adjust the luminance of backlight means. A drive signal for driving the backlight means is then formed by drive signal forming means in accordance with the calculated adjustment value, and the luminance of the backlight means is controlled thereby.

Furthermore, an amplification control is conducted with respect to the image signal for display, on the basis of a linear image luminance correction curve specified by the one-screen average image luminance calculated by the average luminance calculating means, the adjustment value calculated by the adjustment value calculating means, and one or both of the one-screen minimum image luminance and the one-screen maximum image luminance detected by the luminance information detecting means.

In so doing, a backlight level control is appropriately conducted on the basis of a linear luminance adjustment curve, while in addition, an amplification control for the image signal for display is appropriately conducted on the basis of a linear image luminance correction curve that also takes the backlight level control into account. Consequently, reduced power consumption in the backlight of a liquid crystal display element is realized without being dependent on the characteristics of the image signal to be processed, while in addition, images are suitably displayed with reductions in the visibility thereof being prevented.

A display apparatus in accordance with a second embodiment of the present invention is provided with: a liquid crystal display element; backlight means for use with the liquid crystal display element; average luminance calculating means for calculating the one-screen average luminance of an image expressed by an image signal for display; average luminance averaging means for averaging the one-screen average luminance from the average luminance calculating means over a plurality of screens; adjustment value calculating means for calculating an adjustment value used to adjust the luminance of the backlight means on the basis of the average value of the average luminance from the average luminance averaging means, as well as a predetermined linear luminance adjustment curve; drive signal forming means for forming a drive signal used to cause the backlight means to emit light on the basis of the adjustment value calculated by the adjustment value calculating means, and then providing the resulting drive signal to the backlight means; luminance information detecting means for detecting one or both of the one-screen minimum image luminance and the one-screen maximum image luminance in the image signal for display; luminance information averaging means for calculating one or both of the average value of the minimum luminance detected by the luminance information detecting means averaged over a plurality of screens, and the average value of the maximum luminance detected by the luminance information detecting means averaged over a plurality of screens; and image correcting means for conducting an amplification control with respect to the image signal for display on the basis of a linear image luminance correction curve specified by the adjustment value calculated by the adjustment value calculating means, the average value of the average luminance calculated by the average luminance averaging means, and one or both of the minimum luminance averaged over a plurality of screens and the maximum luminance averaged over plurality of screen calculated by the luminance information averaging means, and then providing the corrected image signal to the liquid crystal display element.

According to the display apparatus in accordance with a second embodiment of the present invention, adjustment value calculating means calculates an adjustment value used to adjust the luminance of backlight means on the basis of the value of the average luminance averaged over a plurality of screens by average luminance averaging means with respect to the one-screen average image luminance calculated by average luminance calculating means, as well as on the basis of a predetermined linear luminance adjustment curve. A drive signal for driving the backlight means is then formed by drive signal forming means in accordance with the calculated adjustment value, and the luminance of the backlight means is controlled thereby.

Furthermore, an amplification control is conducted with respect to the image signal for display, on the basis of a linear image luminance correction curve specified by the value of the one-screen average luminance averaged over a plurality of screens by the average luminance averaging means, the adjustment value calculated by the adjustment value calculating means, and one or both of the minimum luminance or the maximum luminance respectively averaged over a plurality of screens by luminance information averaging means with respect to one or both of the one-screen minimum image luminance and the one-screen maximum image luminance detected by luminance information detecting means.

In so doing, a backlight level control is appropriately conducted on the basis of a linear luminance adjustment curve, while in addition, an amplification control for the image signal for display is appropriately conducted on the basis of a linear image luminance correction curve that also takes the backlight level control into account.

Moreover, the above display apparatus is configured to use the value of the one-screen average luminance averaged over a plurality of screens, as well as the one-screen minimum luminance and the one-screen maximum luminance respectively averaged over a plurality of screens. In so doing, both the backlight means luminance control and the image signal amplification control can be appropriately conducted, even in LCD controllers or similar apparatus wherein the image signal is only temporarily stored. Consequently, image signals in a low frame rate state can also be processed, thereby facilitating additional power savings.

Thus, according to an embodiment of the present invention, reduced power consumption in the backlight of a liquid crystal display element is realized without being dependent on the characteristics of the image signal to be processed, while in addition, images are suitably displayed with reductions in the visibility thereof being prevented.

### BRIEF DESCRIPTION OF THE DRAWINGS

FIG. 1 is a block diagram for explaining a display apparatus to which an embodiment of the present invention has been applied;

FIG. 2 is a diagram for explaining an example of a linear luminance adjustment curve (i.e., a linear APL-PWMGAIN curve) used in the PWMGAIN calculation circuit 107 of the display apparatus 100 shown in FIG. 1;

FIG. 3 is a diagram for explaining an example of a linear image luminance correction curve used to conduct luminance control with respect to an image signal in the image correction circuit 104 of the display apparatus 100 shown in FIG. 1;

FIG. 4 is a block diagram for explaining another example of a display apparatus to which an embodiment of the present invention has been applied;

FIG. 5 is a diagram for explaining a basic backlight dimming method of the related art; and

FIG. 6 is a diagram for explaining a problem with a basic backlight dimming method of the related art.

### DESCRIPTION OF THE PREFERRED EMBODIMENTS

Hereinafter, an embodiment of the present invention will be described with reference to the accompanying drawings. By way of example, the embodiment described hereinafter is applied to a display apparatus installed in a mobile phone handset, wherein an LCD is used as the display element, and a white LED is used as the LCD backlight. In addition, in the following detailed description, an image signal is also taken to include signals expressing a plurality of images that collectively form a video sequence. In other words, the image signal herein may also be a video signal. Furthermore, the term “level” herein refers to the luminance of an image signal or backlight, and is thus used synonymously with “luminance” herein.

(Summary of Processing Executed in Display Apparatus)

In order to reduce backlight power consumption, the display apparatus in accordance with the embodiment hereinafter described conducts a backlight level control, as well as an image signal amplification control. However, it should be appreciated that the display apparatus in accordance with the embodiment hereinafter described does not simply dim the backlight or amplify the image signal.

The display apparatus in accordance with the embodiment hereinafter described executes processing combining the following two types of processing.

(1) In the backlight level control, the backlight is controlled so as not to be overly dimmed and make images seem unnatural, even in the case where the average luminance of an image expressed by the image signal to be processed is low.

(2) In the image signal amplification control, the amplification ratio is changed for the bright portions and the dark portions of an image formed by the image signal, such that image saturation and distortion is not noticeable.

In so doing, reduced backlight power consumption is realized by dimming the backlight to a suitable level, even when processing an image signal forming a relatively bright image. At the same time, the display image is prevented from appearing unnatural by conducting the amplification control sensitively with respect to the image signal to be processed.

(Exemplary Configuration of the Display Apparatus)

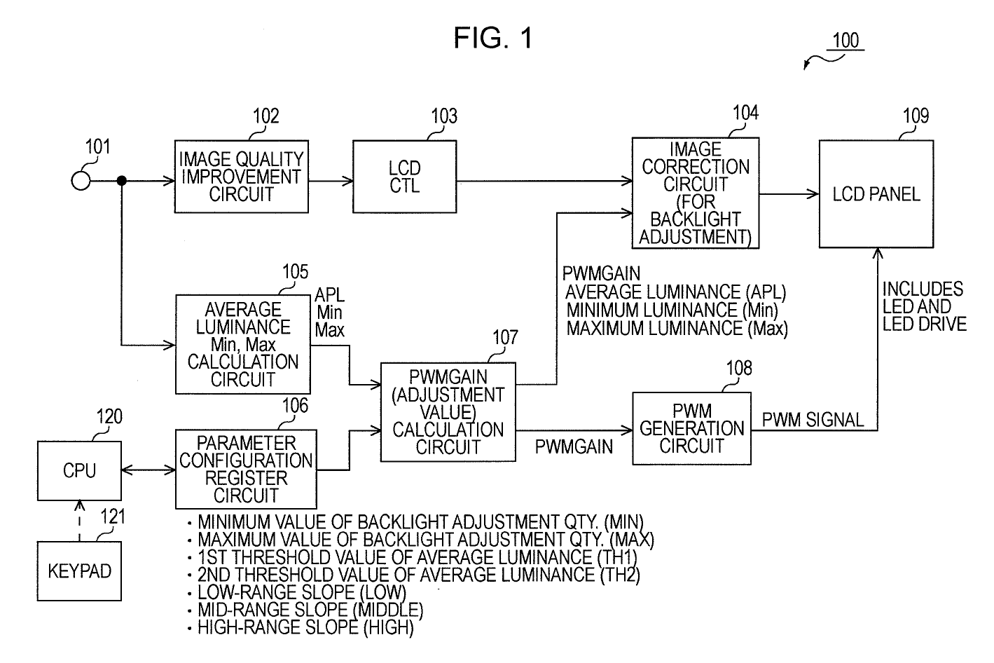

FIG. 1 is a block diagram for explaining the configuration of a display apparatus in accordance with the present embodiment. As shown in FIG. 1, the display apparatus 100 of the present embodiment is provided with an image signal input port 101, an image quality improvement circuit 102, and an LCD controller 103 (labeled LCDCTL in FIG. 1).

The display apparatus 100 of the present embodiment is also provided with an image correction circuit 104, an average luminance, minimum luminance (Min), and maximum luminance (Max) calculation circuit 105 (hereinafter referred to as the luminance calculation circuit), and a parameter configuration register circuit 106.

In addition, the display apparatus 100 of the present embodiment is also provided with a PWMGAIN (i.e., adjustment value) calculation circuit 107, a PWM generation circuit 108, an LCD panel 109, a central processing unit (CPU) 120, and a keypad 121.

An image signal (i.e., digital image data) input via the image signal input port 101 is first input into the image quality improvement circuit 102 and the luminance calculation circuit 105. The image quality improvement circuit 102 performs various image processing with respect to the image signal being processed, such that high-quality image playback is achieved while taking into account the characteristics of the image signal and the characteristics of the LCD panel 109, for example. Having been processed by the image quality improvement circuit 102, the image signal is then supplied to the LCD controller 103.

The LCD controller 103 is made up of components such as video memory and an LCD control circuit. Given a supplied image signal, the LCD controller 103 forms an image signal for displaying an image that is supplied to the LCD panel 109. The image signal for display thus formed in the LCD controller 103 is then supplied to the image correction circuit 104.

The image correction circuit 104 corrects (or adjusts) the luminance of the supplied image signal, while also taking into account the backlight luminance adjustment processing (i.e., the backlight level control) conducted by the functions of the PWMGAIN calculation circuit 107 to be hereinafter described. The image signal thus processed in the image correction circuit 104 is then supplied to the LCD panel 109.

Meanwhile, the luminance calculation circuit 105 calculates the one-screen average image luminance (i.e., the average picture level (APL)) of an individual screen (i.e., frame) formed by the image signal supplied from the image signal input port 101. In addition, the luminance calculation circuit 105 also detects the one-screen minimum image luminance (i.e., the minimum picture level (Min)) and the one-screen maximum image luminance (i.e., the maximum picture level (Max)).

The one-screen average picture level (APL), the one-screen minimum picture level (Min), and the one-screen maximum picture level (Max) solved for by the luminance calculation circuit 105 are then supplied to the PWMGAIN (i.e., the backlight luminance adjustment value) calculation circuit 107.

In addition, seven parameters used to control the luminance of the backlight of the LCD panel 109 are configured in advance in the register of the parameter configuration register circuit 106, the parameters having been input via the keypad 121 and then set via the CPU 120.

As shown in FIG. 1, the seven parameters herein include the minimum value (MIN) and the maximum value (MAX) of the backlight level adjustment value (PWMGAIN).

In addition, the seven parameters also include two threshold values for the average picture level (APL): a first threshold value (a lower threshold value for the average luminance) and a second threshold value (an upper threshold value for the average luminance).

In addition, the seven parameters also include three parameters related to a linear luminance adjustment curve used to specify the actual adjustment value for the backlight luminance. The three parameters are a low-range slope (LOW), a mid-range slope (MIDDLE), and a high-range slope (HIGH), with each parameter being a slope of the linear luminance adjustment curve in respective low, middle, and high regions divided according to the average luminance.

Having been set in the register of the parameter configuration register circuit 106, the above seven parameters are subsequently supplied to the PWMGAIN calculation circuit 107.

In the PWMGAIN calculation circuit 107, a backlight level adjustment value (PWMGAIN) is computed on the basis of the one-screen average image luminance from the luminance calculation circuit 105, as well as the linear luminance adjustment curve determined by the seven parameters from the parameter configuration register circuit 106.

Subsequently, the PWMGAIN calculation circuit 107 supplies the computed backlight level adjustment value (PWMGAIN) to the PWM generation circuit 108. In addition, the PWMGAIN calculation circuit 107 supplies the computed backlight level adjustment value (PWMGAIN) and the three luminance-related values received from the luminance calculation circuit 105 to the image correction circuit 104.

Herein, the three luminance-related values that the PWM generation circuit 108 receives from the luminance calculation circuit 105 and subsequently supplies to the image correction circuit 104 are: the one-screen average picture level (APL), the one-screen minimum picture level (Min), and the one-screen maximum picture level (Max).

On the basis of the backlight level adjustment value (PWMGAIN) supplied from the PWMGAIN calculation circuit 107, the PWM generation circuit 108 forms a PWM signal used to cause the white LED backlight for the LCD panel 109 to emit light. The PWM generation circuit 108 then supplies the PWM signal to the LCD panel 109.

The LCD panel 109 is provided with an LCD, a white LED used as backlight, and an LED drive circuit for the white LED. The LED drive circuit drives the white LED backlight in accordance with the PWM signal supplied from the PWM generation circuit 108.

In accordance with the characteristics of the processing (1) described earlier, the PWMGAIN calculation circuit 107 computes a backlight level adjustment value (PWMGAIN) such that the backlight is not overly dimmed and the image does not become unnatural when the average luminance of an image expressed by the image signal being processed is low. In so doing, the luminance of the white LED acting as the backlight of the LCD panel 109 can be controlled according to the image being processed and not overly lowered.

Meanwhile, in the image correction circuit 104, an amplification quantity for the image signal being processed is computed on the basis of the parameters supplied from the PWMGAIN calculation circuit 107, and then amplification processing is conducted with respect to the image signal supplied from the LCD controller 103. Subsequently, the amplified image signal is supplied to the LCD of the LCD panel 109.

In accordance with the characteristics of the processing (2) described earlier, the image correction circuit 104 modifies the amplification ratio for the bright portions and the dark portions of the image formed by the image signal, such that image saturation and distortion is not noticeable. In so doing, the high-luminance portions of the image signal are not overly amplified, thereby enabling a high-quality image to be displayed on the LCD screen of the LCD panel 109.

In this way, the display apparatus 100 of the present embodiment conducts a luminance control with respect to the white LED acting as the backlight for the LCD panel 109, while also conducting an amplification control with respect to the image signal.

Hereinafter, the processing to calculate (or compute) the backlight level adjustment value (PWMGAIN) conducted by the PWMGAIN calculation circuit 107, and the processing to amplify (i.e., correct) the image signal conducted by the image correction circuit 104 in the display apparatus 100 of the present embodiment will be respectively described in detail.

(Processing Conducted by the PWMGAIN Calculation Circuit 107)

First, the processing conducted by the PWMGAIN calculation circuit 107 in the display apparatus 100 of the present embodiment will be described. As described earlier, the PWMGAIN calculation circuit 107 solves for a backlight level adjustment value (PWMGAIN) by using an average luminance (APL) supplied from the luminance calculation circuit 105.

The backlight level adjustment value (PWMGAIN) may be thought to express the brightness of the backlight, with the backlight being bright to the extent that the value is large. More specifically, assuming the backlight level adjustment value (PWMGAIN) takes a value between 0.0 (min) and 1.0 (max), then the backlight operates at 100% (i.e., the luminance is 100%) when PWMGAIN=1.0.

Furthermore, if the PWMGAIN calculation circuit 107 in the display apparatus 100 of the present embodiment computes the backlight level adjustment value (PWMGAIN) in accordance with the average picture level (APL), then the PWMGAIN calculation circuit 107 computes PWMGAIN on the basis of a linear luminance adjustment curve (i.e., a linear APL-PWMGAIN curve). In this case, the seven pre-configured parameters are used.

The seven parameters are pre-configured in the register of the parameter configuration register circuit 106 in the display apparatus 100. More specifically, the seven parameters include the minimum value (MIN) and the maximum value (MAX) of the backlight level adjustment value (PWMGAIN), as described earlier.

The seven parameters also include a first threshold value (the lower bound of the average luminance) and a second threshold value (the upper bound of the average luminance) for the average picture level (APL). In addition, the seven parameters also include three slope values for the linear luminance adjustment curve used to specify the actual adjustment value: a low-range slope (LOW), a mid-range slope (MIDDLE), and a high-range slope (HIGH) for the respective low, middle, and high ranges of the linear luminance adjustment curve divided according to the average image luminance.

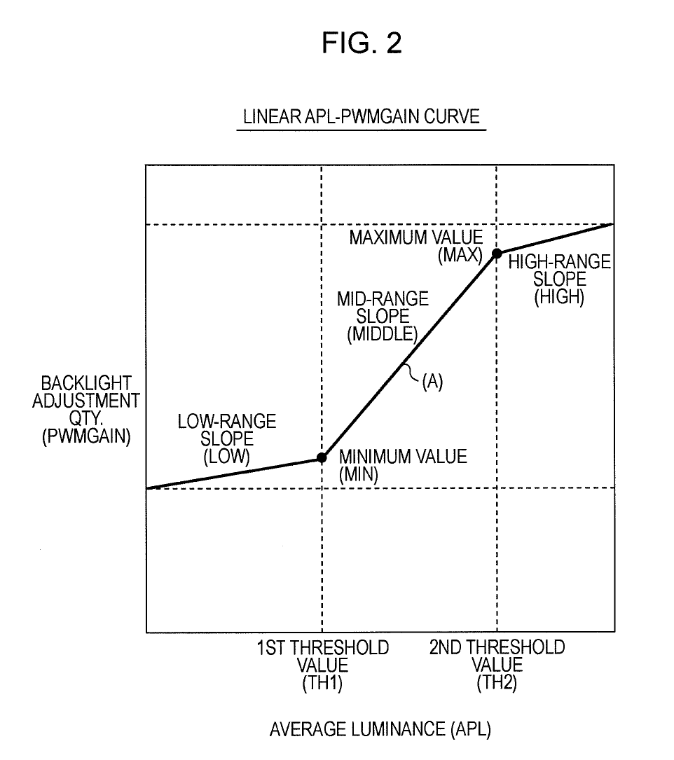

FIG. 2 is a diagram for explaining the relationship between the linear luminance adjustment curve (i.e., the linear APL-PWMGAIN curve) and the above seven parameters used by the PWMGAIN calculation circuit 107 in the display apparatus 100 of the present embodiment.

In FIG. 2, the horizontal axis represents the average picture level (APL), while the vertical axis represents the backlight level adjustment value (PWMGAIN). In addition, in FIG. 2, the linear curve (A) represents the linear luminance adjustment curve (i.e., the linear APL-PWMGAIN curve) for the backlight.

As shown in FIG. 2, the linear luminance adjustment curve (A) is specified using the above seven parameters, which have been determined in advance according to factors such as the characteristics of the LCD panel 109 and the image quality control state.

The maximum value (MAX) and the minimum value (MIN) in FIG. 2 express the maximum value and the minimum value of the backlight level adjustment value (PWMGAIN).

In addition, the first threshold value (TH1) and the second threshold value (TH2) in FIG. 2 express APL points used to modify the backlight adjustment state (i.e., the points dividing the ranges determined according to the average picture level (APL)).

In addition, the low-range slope (LOW), the mid-range slope (MIDDLE), and the high-range slope (HIGH) in FIG. 2 respectively express the slope of the linear luminance adjustment curve (A) in each predetermined range for the average picture level (APL), as described earlier.

Herein, the first threshold value (TH1) and the second threshold value (TH2) described above separate the predetermined ranges for the average picture level (APL). In the PWMGAIN calculation circuit 107 of the display apparatus 100 of the present embodiment, the first threshold value (TH1) and the second threshold value (TH2) are APL points used to divide the linear luminance adjustment curve (A) into three ranges (i.e., regions).

First, the ranges of the average image luminance are divided such that the low region is the range of values less than the first threshold value (TH1), the middle region is the range of values between the first threshold value (TH1) and the second threshold value (TH2), and the high region is the range of values greater than the second threshold value (TH2).

Furthermore, in the display apparatus 100 of the present embodiment, the backlight level adjustment value (PWMGAIN) is not simply compared to the average picture level (APL). As shown in FIG. 2, different adjustments are respectively conducted in the low, middle, and high regions separated by the first threshold value (TH1) and the second threshold value (TH2) (i.e., the APL points). In other words, the display apparatus 100 of the present embodiment is configured to be able to conduct a three-stage adjustment according to the average picture level (APL).

More specifically, in the low range of average picture level (APL), images appear odd if the backlight luminance (i.e., the amount of light) is overly reduced. For this reason, a lower bound for the backlight level adjustment value (PWMGAIN) is set by the minimum value (MIN) of the backlight level adjustment value as shown in FIG. 2, thereby preventing the backlight luminance from being overly reduced.

In addition, if the average picture level (APL) exists in the low region below the first threshold value, then sudden changes in backlight luminance may instead increase the sense of unnaturalness. For this reason, change in the backlight luminance is kept small by the low-range slope (LOW). In this way, when the average picture level (APL) exists in the low region below the first threshold value (TH1), the backlight luminance is made to gradually increase (i.e., in small steps).

Furthermore, when the average picture level (APL) exists in the middle region between the first threshold value (TH1) and the second threshold value (TH2), the average picture level (APL) is neither extremely low nor extremely high.

For this reason, when the average picture level (APL) exists in the middle region between the first threshold value (TH1) and the second threshold value (TH2), the backlight luminance is controlled by the mid-range slope (MIDDLE) so as to change proportionally to change in the average picture level (APL).

If the average picture level (APL) exists in the high region above the second threshold value (TH2), then the image may become saturated or distorted. In consideration of the above, the raising or the backlight luminance is limited by the maximum value (Max) of the backlight level adjustment value.

In addition, when the average picture level (APL) exists in the high region above the second threshold value, increasing the backlight luminance by a large amount readily leads to image saturation and distortion. For this reason, change in the backlight luminance is kept small by the high-range slope (HIGH). In this way, the backlight luminance is also made to gradually increase (i.e., in small steps) when the average picture level (APL) exists in the high region above the second threshold value (TH2).

By following the linear luminance adjustment curve (A) shown in FIG. 2, the respective backlight level adjustment values (PWMGAIN) in the low region, the middle region, and the high region are solved for as follows.

When the average picture level (APL) exists in the low region below the first threshold value (TH1), the backlight level adjustment value (PWMGAIN) is calculated by multiplying the low-range slope (LOW) by the average picture level (APL), and then adding the minimum adjustment value (MIN).

When the average picture level (APL) exists in the middle region between the first threshold value (TH1) and the second threshold value (TH2), the backlight level adjustment value (PWMGAIN) is calculated by multiplying the mid-range slope (MIDDLE) by the average image luminance for that region (APL-TH1), and then adding the adjustment value (PWMGAIN) for the first threshold value (TH1).

When the average picture level (APL) exists in the high region above the second threshold value (TH2), the backlight level adjustment value (PWMGAIN) is calculated by multiplying the high-range slope (HIGH) by the average image luminance for that region (APL-TH2), and then adding the adjustment value (PWMGAIN) for the second threshold value (TH2).

In so doing, the backlight level adjustment value (PWMGAIN) is kept less than or equal to a predetermined maximum value (Max) as shown in FIG. 2, even when the average picture level (APL) increases to a high level.

Moreover, the backlight level adjustment value (PWMGAIN) is kept equal to or greater than a predetermined minimum value (MIN) as shown in FIG. 2, even when the average picture level (APL) decreases to a low level.

In addition, when the average picture level (APL) exists in either a low portion (i.e., the low region) below the first threshold value (TH1) or a high portion (i.e., the high region) above the second threshold value (TH2), change in the backlight level adjustment value (PWMGAIN) is kept small.

When the average picture level (APL) exists in the portion between the first threshold value and the second threshold value, the backlight level adjustment value (PWMGAIN) is controlled proportionally to the average image luminance.

By conducting the above series of controls with respect to the backlight, reduced backlight power consumption is realized. Furthermore, the effects that change in backlight luminance exerts with respect to an image displayed on the LCD are reduced, thereby preventing images displayed on the LCD from appearing unnatural.

In other words, the backlight luminance is kept at or below the maximum value (MAX) overall, and when the average image luminance exists in the portion below the first threshold value (TH1), the backlight luminance is also maintained near the backlight minimum value (MIN). Consequently, reduced power consumption in the backlight is realized.

Moreover, since change in the backlight luminance is kept small when the average picture level (APL) exists in the portion below the first threshold value (TH1), displayed images are prevented from appearing unnatural. Additionally, since change in the backlight luminance is similarly kept small when the average picture level (APL) exists in the portion above the second threshold value (TH2), saturation and distortion effects are also reduced.

In addition, when the average image luminance exists in the range between the first threshold value (TH1) and the second threshold value (TH2), the backlight luminance is controlled in accordance with the average picture level (APL), and thus displayed images are not made to appear unnatural.

In this way, in the display apparatus 100 of the present embodiment, a linear luminance adjustment curve (A) formed as described with reference to FIG. 2 is used, thereby enabling the adjustment value for the backlight luminance (i.e., the backlight luminance value) to be suitably determined on the basis of the average picture level (APL).

It should be appreciated that by adjusting the seven parameters described earlier, the display apparatus 100 may be configured to prioritize reduced power consumption at the expense of somewhat darker displayed images. In contrast, the display apparatus 100 may also be configured to prioritize image quality at the expense of a less pronounced reduction in power consumption.

In addition, the seven parameters that are actually used may also be modified according to the characteristics of the LCD panel being used and the image quality control state. In the display apparatus 100 of the present embodiment herein, the seven parameters described above are specified in advance on the basis of repeated experiments to optimize settings with respect to the LCD panel or other components being used.

The low-range slope (LOW) and the high-range slope (HIGH) described earlier are herein taken to be slopes defining rates of change not greater than that of the average luminance. Principally, the low-range slope (LOW) and the high-range slope (HIGH) take values less than or equal to 1. More specifically, the low-range slope (LOW) and the high-range slope (HIGH) may take values such as 0.5 and 0.7.

In addition, the mid-range slope (MIDDLE) is herein taken to be proportional to the rate of change of the average luminance. More specifically, the mid-range slope (MIDDLE) takes a value near or equal to 1, and in some cases may take a value greater than 1.

Herein, two threshold values (the first threshold value and the second threshold value) for the average picture level (APL) are used to divide the average image luminance domain into three regions (a low region, a middle region, and a high region). A slope for the linear luminance adjustment curve (A) is then set for each region, and backlight luminance adjustment is conducted therewith. However, the present invention is not limited to the above.

It is also possible to set a single threshold value for the average picture level, thereby dividing the average image luminance domain into two regions (a low region and high region). A slope for the linear luminance adjustment curve (A) is then set for each of the two regions, and backlight level adjustment is conducted therewith.

It is also possible to set three or more threshold values for the average picture level, thereby dividing the average picture level domain into four or more regions. A slope for the linear luminance adjustment curve (A) is then set for each of the four or more regions, and backlight level adjustment is then conducted therewith.

In other words, the number of threshold values for the average picture level is not limited to two. One or more threshold values may be provided as appropriate to enable backlight level adjustment to be suitably conducted in accordance with the characteristics of the display apparatus or other factors.

(Processing Conducted by the Image Correction Circuit 104)

The processing conducted by the image correction circuit 104 in the display apparatus 100 of the present embodiment will now be described. Together with the backlight level control conducted by the PWMGAIN calculation circuit 107 described above, the image correction circuit 104 conducts an image signal amplification control in order to prevent images displayed on the LCD from appearing unnatural.

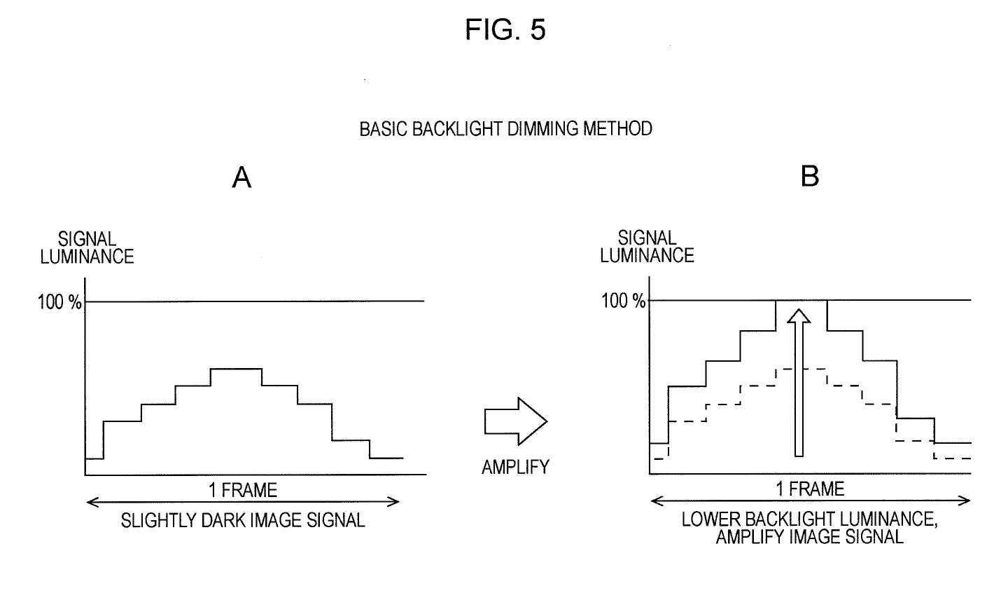

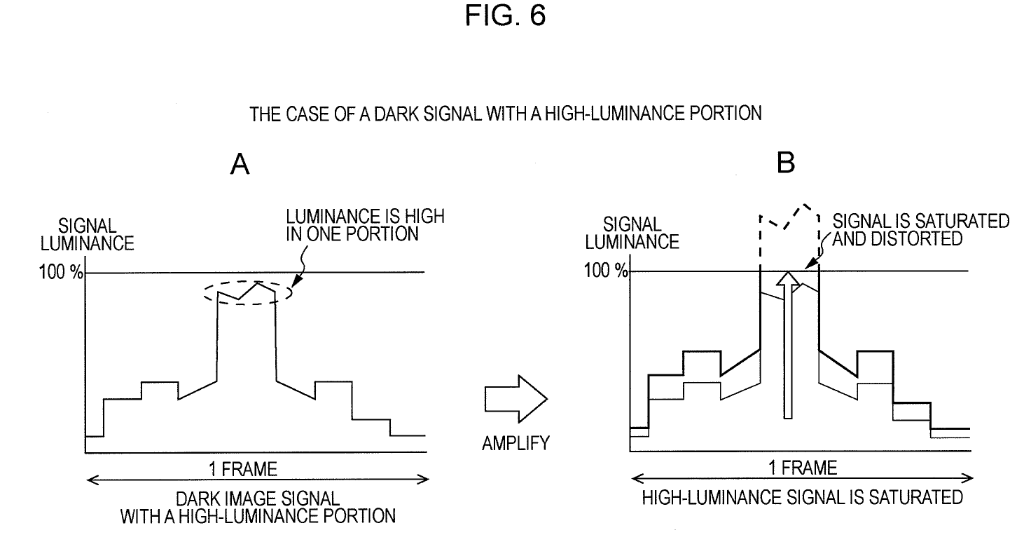

As described earlier with reference to FIGS. 5 and 6, there are many cases wherein the image quality of an image displayed on an LCD is degraded when the image signal forming the image is simply amplified to the extent that the backlight luminance is lowered. Particularly, saturation and distortion of the image signal occurs when amplifying image portions having a high luminance.

Consequently, given an image signal to be processed, the image correction circuit 104 in the display apparatus 100 of the present embodiment sets a large amplification ratio for the part of the image signal corresponding to image portions having a relatively low luminance, while setting a small amplification ratio for the part of the image signal corresponding to image portions having a relatively high luminance.

In so doing, a two-stage luminance control can be conducted with respect to the luminance of an image signal. The luminance control for the image signal is conducted on the basis of a linear image luminance correction curve that may be predetermined or automatically configured.

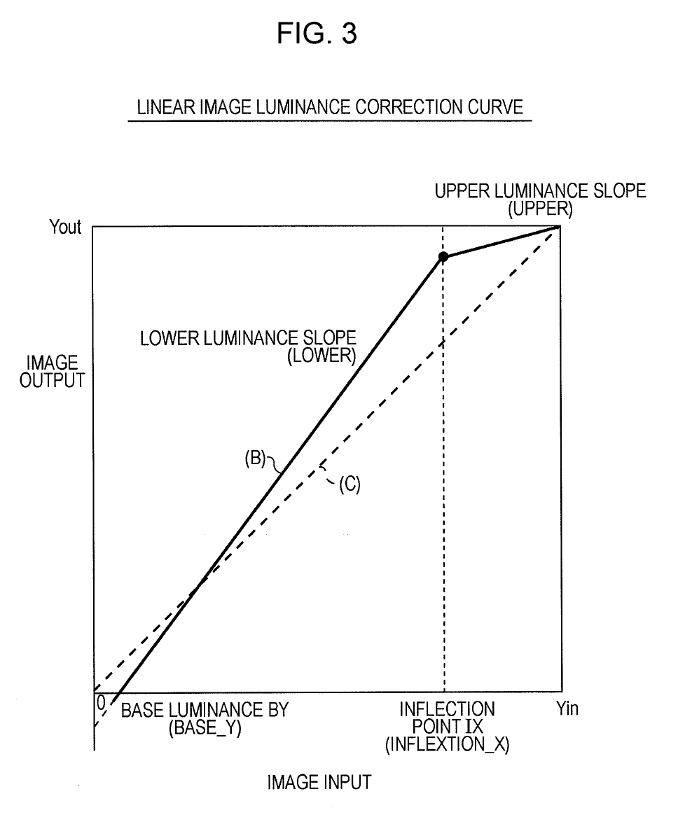

FIG. 3 is a diagram for explaining an example of a linear image luminance correction curve used to conduct an image signal luminance control in the image correction circuit 104 of the display apparatus 100 of the present embodiment.

In FIG. 3, the horizontal axis represents the luminance value Yin of the input image signal, while the vertical axis represents the luminance value Yout of the output image signal. In addition, the linear curve (B) shown as a solid line in FIG. 3 is the linear image luminance correction curve used to correct the luminance of the image signal. The linear curve (C) shown as a broken line in FIG. 3 has a slope of 1 shown for comparison.

As shown in FIG. 3, when the input image signal luminance value Yin exists in the portion below a predetermined inflection point IX (INFLEXTION_X), the slope of the linear image luminance correction curve (B) becomes a lower luminance slope (LOWER). When the input image signal luminance value Yin exists in the portion at or above the predetermined inflection point IX (INFLEXTION_X), the slope becomes an upper luminance slope (UPPER).

In addition to the lower luminance slope (LOWER) and the upper luminance slope (UPPER), there also exist a base luminance BY (BASE_Y) and the inflection point IX (INFLEXTION_X) described above.

The base luminance BY (BASE_Y) is used to fix the value of the output signal luminance value Yout to 0 when the value of the input signal luminance value Yin is near 0, thereby enabling the user to perceive the black portions of images as being black without appearing odd.

The base luminance BY (BASE_Y) thus fixes the value of the output signal luminance value Yout to 0 when the value of the input signal luminance value Yin is near 0. As a result, the user is able to perceive black on the display screen as natural-looking black.

As described earlier, the inflection point IX (INFLEXTION_X) indicates the inflection point for the slope of the linear image luminance correction curve (B). In other words, the slope of the linear image luminance correction curve (B) becomes the lower luminance slope (LOWER) in the portion where the luminance value is lower than the inflection point IX (INFLEXTION_X). In addition, the slope of the linear image luminance correction curve (B) becomes the upper luminance slope (UPPER) in the portion where the luminance value is higher the inflection point IX (INFLEXTION_X).

It is possible to manually configure the above four parameters in advance. However, it is also possible to automatically configure the above four parameters, which will be later described in detail. By using the above four parameters, the image luminance correction state (i.e., the state of the amplification control) with respect to the image signal being processed can be changed.

Furthermore, by following the linear image luminance correction curve (B) shown in FIG. 3, the image luminance in the portion where the luminance value is lower than the inflection point IX (INFLEXTION_X) and the image luminance in the portion where the luminance value is higher than the inflection point IX (INFLEXTION_X) are solved for as follows.

When the input signal luminance value Yin exists in the region below the inflection point IX (INFLEXTION_X), the output signal luminance value Yout is calculated by multiplying the lower luminance slope (LOWER) by the input signal luminance value Yin, and then adding the base luminance BY (BASE_Y).

When the input signal luminance value Yin exists in the region at or above the inflection point IX (INFLEXTION_X), the output signal luminance value Yout is calculated by multiplying the upper luminance slope (UPPER) by the difference between the signal luminance value Yin and the inflection point IX (i.e., the luminance value thereof), and then adding the inflection point IX.

In the linear image luminance correction curve (B) shown in FIG. 3, the slope may be thought of as being virtually identical to the amplification ratio of the image signal luminance. For this reason, the amplification ratio is high in the portion where the slope is large (i.e., the lower luminance slope (LOWER)). In contrast, the amplification ratio is low in the portion where the slope is small (i.e., the upper luminance slope (UPPER)). Consequently, when the slope is less than 1, as it is in the portion of the upper luminance slope (UPPER) shown in FIG. 3, the image luminance changes in the direction of attenuation.

In the case of an image signal, a high amplification ratio corresponds to improved contrast. Consequently, although the contrast is improved for low luminance values in FIG. 3, there is a possibility that the contrast may worsen for portions where the luminance is high.

However, as described earlier, the two-stage image luminance correction processing for a image signal (i.e., the image signal amplification control) is conducted according to the linear image luminance correction curve (B) shown in FIG. 3. In so doing, the effects imparted by the correction processing to the high-luminance portions of the image signal can be suppressed. As a result, images are prevented from appearing unnatural.

In other words, the image luminance is mildly amplified for portions in the image where the luminance is high, and thus adverse effects such as saturation of the image signal and distortion of the displayed image is prevented, and high-quality images are displayed.

(Specific Method for Specifying Parameters)

A method for specifying the four parameters used in the image correction circuit 104 (i.e., the lower luminance slope (LOWER), the upper luminance slope (UPPER), the base luminance BY (BASE_Y), and the inflection point IX (INFLEXTION_X)) will now be described.

It is possible to experimentally find and set suitable values in advance for the four parameters used in the image correction circuit 104. It is also possible to investigate the properties of an image input in advance by software processing or similar means, and then set the above four parameters according to the processing results.

However, the image signal luminance correction processing conducted in the image correction circuit 104 is preferably conducted in association with the LCD backlight level control conducted in the PWMGAIN calculation circuit 107.

Consequently, in the image correction circuit 104 of the display apparatus 100 of the present embodiment, the lower luminance slope (LOWER) is determined on the basis of the backlight level adjustment value (PWMGAIN) computed in the PWMGAIN calculation circuit 107.

In addition, the upper luminance slope (UPPER) and the base luminance BY (BASE_Y) are determined on the basis of the one-screen average picture level (APL) as well as the one-screen minimum (Min) and maximum (Max) picture levels.

Once the above three parameters have been determined, the inflection point IX (INFLEXTION_X) can be solved by means of a simple calculation using the three parameters.

Hereinafter, a specific method for specifying the lower luminance slope (LOWER), the upper luminance slope (UPPER), the base luminance BY (BASE_Y), and the inflection point IX (INFLEXTION_X) will be described.

First, the method for specifying the lower luminance slope (LOWER) will be described. The lower luminance slope (LOWER) is set in the PWMGAIN calculation circuit 107 such that the input signal level is amplified to the extent that the backlight level is lowered. More specifically, if the backlight level has been lowered to a level p (=PWMGAIN), then the input signal level is multiplied by 1/p=p⁻¹.

In practice, however, images displayed on the LCD panel 109 are also gamma-corrected. Herein, the case of a typical gamma value of 2.2 in the LCD panel and a base backlight level of 1.0 (100%) will be considered. In addition, the units for backlight level and picture level (i.e., the units of luminance) herein are cd/m², or “nits”.

In this case, if the backlight level is relatively lowered to the level p, then the surface luma Y′ in the case where an image with identical pixel levels is displayed can be expressed using the original luminance Y as Y′=Yp^{1/2.2}. In other words, the surface luma Y′ can be solved for by multiplying the original luminance Y of the image by the backlight level p raised to the 1/2.2 power.

Consequently, in the display apparatus 100 of the present embodiment, the lower luminance slope (LOWER) is set by performing a reverse transformation with respect to Y′=Yp^{1/2.2}. In other words, the lower luminance slope (LOWER) is set to be p^{-1/2.2} (p raised to the −1/2.2 power). Obviously, the lower luminance slope (LOWER) is not limited to this value, and may be set to another appropriate value depending on the particular gamma value used.

Meanwhile, the upper luminance slope (UPPER) is set by experiment using the display apparatus 100 to take a value in the range between 0.65 and 1.0, depending on the values of the one-screen average picture level (APL) and one-screen maximum picture level (Max).

Consequently, a table is established for determining a single value for the upper luminance slope (UPPER) belonging to the range between 0.65 and 1.0, on the basis of the one-screen average picture level (APL) and the one-screen maximum picture level (Max). The table herein is established in advance in a predetermined memory area inside the image correction circuit 104.

As a result, if the value of the one-screen average picture level (APL) is a, and the value of the one-screen maximum picture level (Max) is b, for example, then the value of the upper luminance slope (UPPER) becomes 0.65. In this way, the upper luminance slope (UPPER) is uniquely determined by the average picture level (APL) and the maximum picture level (Max).

The base luminance BY (BASE_Y) is set by experiment using the display apparatus 100 to take a value in the range between 0 and −22, depending on the value of the one-screen minimum picture level (Min).

Consequently, a table is established for determining a single value for the base luminance BY (BASE_Y) belonging to the range between 0 and −22, on the basis of the one-screen minimum picture level (Min). The above table is similarly established in advance in a predetermined memory area inside the image correction circuit 104.

As a result, if the value of the one-screen minimum picture level (Min) is c, then the base luminance BY (BASE_Y) becomes −5.0. In this way, the base luminance BY (BASE_Y) is uniquely determined by the one-screen minimum picture level (Min).

It should be appreciated that the base luminance BY (BASE_Y) is not limited to being solely determined by the one-screen minimum picture level (Min), and of course may also be determined by a combination of the one-screen minimum picture level (Min) and the average picture level (APL).

The inflection point IX (INFLEXTION_X) can be solved for by calculation based on the above three parameters (i.e., the lower luminance slope (LOWER), the upper luminance slope (UPPER), and the base luminance BY (BASE_Y)).

More specifically, the linear image luminance correction curve (B) in the region where the input signal luminance value Yin is lower than the inflection point IX is expressed by the following Eq. 1.

Yout=lower luminance slope (LOWER)×input signal luminance value Yin+base luminance BY (1)

In addition, the linear image luminance correction curve (B) in the region where the input signal luminance value Yin is higher than the inflection point IX is expressed by the following Eq. 2.

Yout=upper luminance slope (UPPER)×input signal luminance value Yin+intercept m on Yout axis (2)

Herein, if the maximum value of the picture level is taken to be 1.0 (i.e., a luminance of 100%), then when the value of the input signal luminance value Yin is 1.0, the value of the output signal luminance value Yout also becomes 1.0. Consequently, the intercept m on the vertical axis (i.e., the Yout axis) can be solved for using the following Eq. 3.

Intercept m on Yout axis=1.0−lower luminance slope (LOWER) (3)

The inflection point IX (INFLEXTION_X) to be solved for thus becomes the value of the input signal luminance value Yin in the case where the above Eqs. 1 and 2 are equal (i.e., at the position where the lines in Eqs. 1 and 2 intersect).

The lower luminance slope (LOWER) can thus be determined on the basis of the adjustment value (PWMGAIN) from the PWMGAIN calculation circuit.

In addition, the upper luminance slope (UPPER) and the base luminance BY (BASE_Y) can thus be determined by referencing information in tables established in advance on the basis of either the average picture level (APL) and the maximum picture level (Max), or on the basis of the minimum picture level (Min).

In addition, the inflection point IX (INFLEXTION_X) can thus be solved for by calculation on the basis of the three parameters determined above (i.e., the lower luminance slope (LOWER), the upper luminance slope (UPPER), and the base luminance BY (BASE_Y)).

Using the parameters thus specified, an optimal linear image luminance correction curve (B) is specified for each screen, on the basis of one-screen luminance-related information in the image signal being processed, as well as the backlight level adjustment value (PWMGAIN).

On the basis of the linear image luminance correction curve (B) thus specified, suitable amplification control can be conducted with respect to an input signal.

Herein, the lower luminance slope (LOWER) described above is proportional to change in the image luminance of the images being processed. More specifically, the lower luminance slope (LOWER) may be near or equal to 1, and in some cases may take a value greater than 1. Meanwhile, the upper luminance slope (UPPER) is less than or equal to the change in the image luminance of the images being processed. Principally, the upper luminance slope (UPPER) takes a value less than or equal to 1. More specifically, the upper luminance slope (UPPER) takes values such as 0.5 and 0.7.

As has been made clear from the description of the display apparatus 100 of the foregoing embodiment, the PWMGAIN calculation circuit 107 and the image correction circuit 104 function to suitably adjust the backlight luminance of the LCD panel 109, thereby reducing backlight power consumption. Moreover, since the luminance of the image signal being processed is also suitably controlled simultaneously with the backlight level control, displayed images are not degraded.

Using the display apparatus 100 of the present embodiment, it has been confirmed by experiment that it is possible to reduce power consumption by 20% to 50% compared to display apparatus of the related art when displaying still images of normal landscapes and portraits. Furthermore, it has been confirmed that it is possible to reduce power consumption by approximately 30% to 80% when displaying video, due to the characteristic of video having a comparatively large number of dark image portions.

In the display apparatus 100 of the foregoing embodiment, a backlight level control and an image signal amplification control can be suitably conducted on the basis of simple parameters such as the average picture level (APL), the minimum picture level (Min), and the maximum picture level (Max).

Moreover, the backlight level control and the image signal amplification control can be conducted by means of relatively small-scale circuits, such as the image correction circuit 104, the luminance calculation circuit 105, the parameter configuration register circuit 106, and the PWMGAIN calculation circuit 107.

Since the scale of the circuitry that conducts the backlight level control and the image signal amplification control is relatively small, the power used for image correction is also slight, and thus an embodiment of the present invention may be installed in series after the LCD controller, even in high frame rate apparatus.

In other words, the display apparatus 100 of the present embodiment realizes a backlight emission control and an image signal amplification control by following a new and relatively simply algorithm, and furthermore without increasing the scale of the circuitry.

In the display apparatus 100 shown in FIG. 1, the image correction circuit 104, the luminance calculation circuit 105, the parameter configuration register circuit 106, and the PWMGAIN calculation circuit 107 are disposed after the LCDCTL 103.

For this reason, in the display apparatus 100 shown in FIG. 1, an image signal processed by the image quality improvement circuit 102 is subsequently used in the LCDCTL 103 to form an image signal for display that is supplied to the LCD panel 109, which is then accumulated in memory before being supplied to the image correction circuit 104.

Consequently, the processing in the luminance calculation circuit 105, the parameter configuration register circuit 106, and the PWMGAIN calculation circuit 107 is conducted while the image signal is being processed in the image quality improvement circuit 102 and the LCDCTL 103.

As a result, the processing in the image correction circuit 104 and the processing in the PWM generation circuit 108 are conducted simultaneously. Consequently, the above configuration enables the luminance control-induced backlight drive control of the LCD panel 109 performed in accordance with the PWM signal to be synchronized with the amplification control-induced image signal display processing in the display apparatus 100 described above.

In the image correction circuit 104 in the display apparatus 100 of the present embodiment described with reference to FIGS. 1 to 3, the base luminance BY (BASE_Y) is configured on the basis of the one-screen minimum picture level (Min). However, it should be appreciated that solving for the one-screen minimum picture level (Min) may be omitted in the case where the base luminance BY (BASE_Y) is set to a fixed value.

Consequently, in the above case, just the one-screen maximum picture level (Max) may be solved for, and then the upper luminance slope (UPPER) may be appropriately solved for using the maximum picture level (Max) and the average picture level (APL).

In addition, solving for the one-screen maximum picture level (Max) may be omitted in the case where the upper luminance slope (UPPER) can be set to a fixed value by means of advance tests of the display apparatus 100, for example.

Consequently, in the above case, just the one-screen minimum picture level (Min) is solved for, and then the base luminance BY (BASE_Y) may be appropriately solved for on the basis of the minimum picture level (Min).

In this way, in the case where either the upper luminance slope (UPPER) or the base luminance BY (BASE_Y) is to be set to a fixed value, either the one-screen minimum picture level (Min) or the one-screen maximum picture level (Max) may be solved for in order to determine the other parameter that is not set to a fixed value.

(Modifications)

Meanwhile, the frame rate of content for mobile phone handsets is approximately 5 FPS to 30 FPS (frames per second), even for video. However, the frame rate of post-LCD controller video is raised to approximately 60 FPS.

In principal, this raising of the frame rate is performed in order to maintain high image quality, wherein the image data for image display that is formed by the LCD controller repeatedly supplies the LCD with the same image signal until an image signal for a new image is supplied.

As described earlier, since an embodiment of the present invention has small-scale circuitry and low control-related power consumption, such an embodiment is favorable even when applied after the LCD controller. However, in some cases, an embodiment of the present invention may be applied before the LCD controller in order to further suppress power draw by the circuits.

Consequently, a display apparatus 200 in accordance with a modification of an embodiment of the present invention and hereinafter described is configured to be able to conduct a backlight level control and an image signal amplification control before the LCD controller.

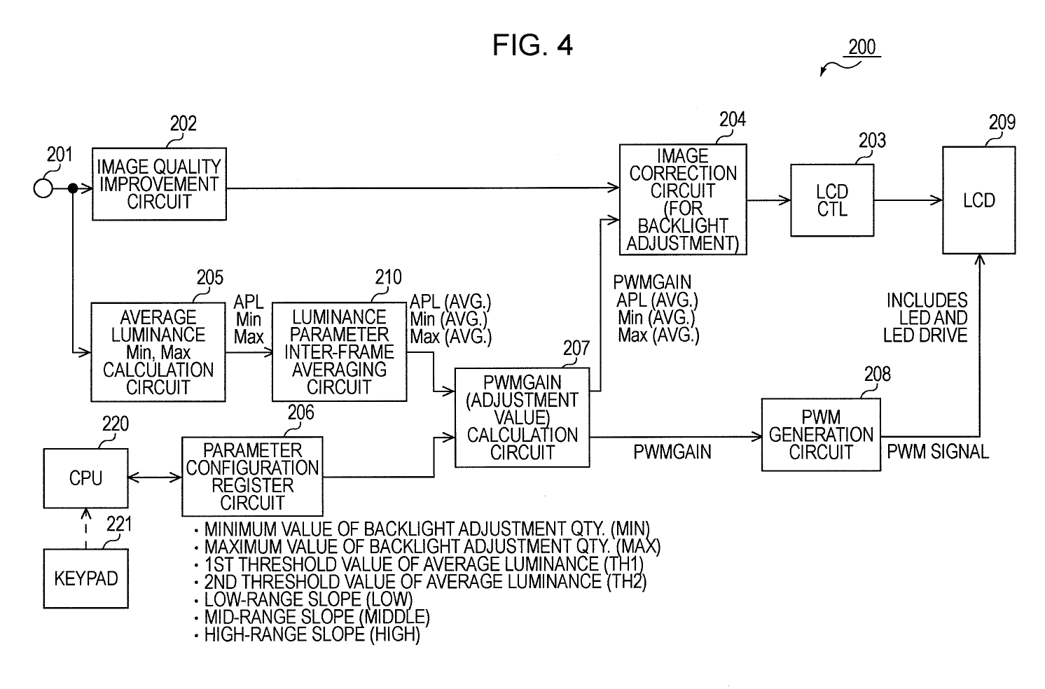

FIG. 4 is a block diagram for explaining the display apparatus 200 in accordance with the present modification. As shown in FIG. 4, the display apparatus 200 of the present example is provided with an image signal input port 201, an image quality improvement circuit 202, and an LCD controller 203 (labeled LCDCTL in FIG. 4).

The display apparatus 200 of the present example is also provided with an image correction circuit 204, an average luminance, minimum luminance (Min), and maximum luminance (Max) calculation circuit 205 (hereinafter referred to as the luminance calculation circuit), and a parameter configuration register circuit 206.

In addition, the display apparatus 200 of the present example is also provided with a PWMGAIN (i.e., adjustment value) calculation circuit 207, a PWM generation circuit 208, an LCD panel 209, a luminance parameter inter-frame averaging circuit 210, a central processing unit (CPU) 220, and a keypad 221.

Herein, respective circuits among the circuits provided in the display apparatus 200 shown in FIG. 4 that correspond to (i.e., share names with) circuits in the display apparatus 100 shown in FIG. 1 have functions similar to those of the corresponding circuits described with reference to the display apparatus 100 shown in FIG. 1.

However, as can be understood upon comparison of the display apparatus 200 shown in FIG. 4 with the display apparatus 100 shown in FIG. 1, the following two significant differences also exist.

First, the display apparatus 200 shown in FIG. 4 significantly differs from the display apparatus 100 shown in FIG. 1 in that the image correction circuit 204, the luminance calculation circuit 205, the parameter configuration register circuit 206, and the PWMGAIN calculation circuit 207 are provided before the LCDCTL 203.

Second, the display apparatus 200 shown in FIG. 4 differs from the display apparatus 100 shown in FIG. 1 in that the display apparatus 200 additionally includes a luminance parameter inter-frame averaging circuit 210 between the luminance calculation circuit 205 and the PWMGAIN calculation circuit 207.

In the display apparatus 200 shown in FIG. 4, the luminance parameter inter-frame averaging circuit 210 enables components such as the image correction circuit 204 and the PWMGAIN calculation circuit 207 to be provided before the LCDCTL 203.

More specifically, in the case of the display apparatus 100 shown in FIG. 1, the image correction circuit 104, the luminance calculation circuit 105, the parameter configuration register circuit 106, and the PWMGAIN calculation circuit 107 are provided before the LCDCTL 103.

For this reason, circuits such as the PWMGAIN calculation circuit 107 are able to function and conduct both the backlight level control and the image signal amplification control with respect to the same image signal during the holding period of the image signal in LCDCTL 103, as described earlier.

In contrast, in the case of the display apparatus 200 shown in FIG. 4, circuits such as the image correction circuit 204 and the PWMGAIN calculation circuit 207 are provided after the LCDCTL 203. For this reason, the average luminance, the minimum luminance, and the maximum luminance for a given image signal, as well as the backlight adjustment value (PWMGAIN), are not calculated by the time that image signal output from the image quality improvement circuit 202 is supplied to the image correction circuit 204.

Consequently, in the display apparatus 200 shown in FIG. 4, the luminance parameter inter-frame averaging circuit 210 solves for the average value of, for example, the average picture levels (APL) of the two most recent frames for which average picture levels (APL) have already been calculated by the luminance calculation circuit 205.

More specifically, the luminance parameter inter-frame averaging circuit 210 calculates the average of the average picture levels (APL), the average of the minimum picture levels (Min), and the average of the maximum picture levels (Max) for the two most recent frames, and then supplies the results to the PWMGAIN calculation circuit 207.

The PWMGAIN calculation circuit 207 then uses the average of the average picture levels (APL) from the luminance parameter inter-frame averaging circuit 210 to calculate the backlight level adjustment value (PWMGAIN). In other words, the PWMGAIN calculation circuit 207 functions identically to the PWMGAIN calculation circuit 107 shown in FIG. 1, except in that instead of the average picture level (APL), the average of the average picture level (APL) is used therein.

Consequently, in the PWMGAIN calculation circuit 207 shown in FIG. 4, the linear luminance adjustment curve (A) described with reference to FIG. 2 is specified on the basis of the seven parameters supplied from the parameter configuration register circuit 206.

Furthermore, in the PWMGAIN calculation circuit 207, the backlight level adjustment value (PWMGAIN) is calculated according to the average of the average picture levels (APL) supplied from the luminance parameter inter-frame averaging circuit 210, and then supplied to the PWM generation circuit 208.

Similarly to the PWM generation circuit 108 shown in FIG. 1, the PWM generation circuit 208 forms a PWM signal in accordance with the adjustment value (PWMGAIN) supplied from the PWMGAIN calculation circuit 207, and then supplies the PWM signal to the LED drive of the LCD panel 209. In so doing, a luminance control can be conducted with respect to the LED acting as the backlight.

Meanwhile, the PWMGAIN calculation circuit 207 supplies the calculated backlight level adjustment value (PWMGAIN) to the image correction circuit 204, while additionally supplying the luminance-related information from the luminance parameter inter-frame averaging circuit 210 to the image correction circuit 204.

As also shown in FIG. 4, the luminance-related information herein includes the inter-frame average (APL (avg.)) of the average picture levels (APL), the inter-frame average (Min (avg.)) of the minimum picture levels, and the inter-frame average (Max (avg.)) of the maximum picture levels.

Similarly to the image correction circuit 104 shown in FIG. 1, the image correction circuit 204 specifies the linear image luminance correction curve (B) to be used with respect to the image signal supplied from the image quality improvement circuit 202 on the basis of the four parameters described with reference to FIG. 3.

Subsequently, the image correction circuit 204 uses the specified linear image luminance correction curve (B) to conduct an amplification control with respect to the image signal supplied from the image quality improvement circuit 202, on the basis of the information supplied from the PWMGAIN calculation circuit 207. The post-amplification control image signal is then supplied to the LCDCTL 203.

The LCDCTL 203 then forms an image signal to be supplied to the LCD panel 209 from the amplification-controlled image signal supplied from the image correction circuit 204. The resulting image signal is then supplied to the LCD panel 209.

In so doing, images corresponding to the amplification-controlled image signal are displayed on the LCD screen of the LCD panel 209. In addition, the backlight LED of the LCD panel 209 is driven by a PWM signal created to control the backlight luminance.

Consequently, the display apparatus 200 of the present modification shown in FIG. 4 is similarly able to suitably conduct a backlight level control in accordance with the linear luminance adjustment curve (i.e., the linear APL-PWMGAIN curve) described with reference FIG. 2.

At the same time, the display apparatus 200 is also able to conduct an amplification control with respect to an image signal to be displayed, in accordance with the linear image luminance correction curve described with reference to FIG. 3.

In this way, even when the circuits in accordance with an embodiment of the present invention are provided before the LCDCTL 203, a backlight level control can be suitably conducted, and reduced backlight power consumption can be realized.

Moreover, since an amplification control with respect to an image signal to be displayed can also be suitably conducted in accordance with the backlight level control, high-quality images can be displayed without producing image saturation or distortion.

In addition, in the case of the display apparatus 200 shown in FIG. 4, circuits such as the image correction circuit 204 and the PWMGAIN calculation circuit 207 can be provided before the LCDCTL 203. As a result, the backlight level control and the image signal amplification control can be conducted with respect to an image signal having a relatively low frame rate prior to being processed by the LCDCTL 203. Consequently, the power consumption involved in the backlight level control and the image signal amplification control can be prevented from becoming overly large.

Herein, the luminance parameter inter-frame averaging circuit 210 in the modification shown in FIG. 4 may also be configured to solve for average values with respect to a larger plurality of frames, within a range allowed by the processing time. In addition, the luminance parameter inter-frame averaging circuit 210 may of course also be configured to use weighted averages of a plurality of frames.

In the modification shown in FIG. 4, the PWMGAIN calculation circuit 207 uses a first threshold value and a second threshold value for the average value of the average picture levels (APL), thereby dividing the domain of the average values of average picture levels into three regions: a low region, a middle region, and a high region. A slope for the linear luminance adjustment curve (A) is then set for each respective region, and the backlight luminance is then adjusted therewith. However, the present invention is not limited to the above.

It is also possible to set just one threshold value for the average value of the average picture levels, thereby dividing the domain of the average value of average picture levels into two regions: a low region and a high region. A slope for the linear luminance adjustment curve (A) may then be set for each respective region, and the backlight luminance may then be adjusted therewith.

In addition, it is also possible to set three or more threshold values for the average value of the average picture levels, thereby dividing the domain of the average value of average picture levels into four or more regions. A slope for the linear luminance adjustment curve (A) may then be set for each of the four or more regions, and the backlight luminance may then be adjusted therewith.

In other words, the number of threshold values for the average value of average picture levels is not limited to two. One or more threshold values may be provided as appropriate to enable backlight luminance adjustment to be suitably conducted in accordance with the characteristics of the display apparatus or other factors.

Herein, the modification described with reference to FIG. 4 is configured to use the average value of average picture levels, the average value of minimum picture levels, and the average value of maximum picture levels. Theoretically, however, the above is equivalent to using the average picture level (APL), the minimum picture level (Min), and the maximum picture level (Max), similar to the case of the display apparatus 100 described with reference to FIG. 1.

In addition, in the modification shown in FIG. 4, the image correction circuit 204 is configured to configured the base luminance BY (BASE_Y) on the basis of the average value of the one-screen minimum picture level (Min). However, solving for the average value of the one-screen minimum picture level (Min) may be omitted in the case where the base luminance BY (BASE_Y) is to be set to a fixed value.

Consequently, in the above case, just the one-screen maximum picture level (Max) may be solved for, and then the upper luminance slope (UPPER) may be appropriately solved for using the maximum picture level (Max) and the average picture level (APL).

In addition, solving for the one-screen maximum picture level (Max) may be omitted in the case where the upper luminance slope (UPPER) can be set to a fixed value by means of advance tests of the display apparatus 200 shown in FIG. 4, for example.

Consequently, in the above case, just the one-screen minimum picture level (Min) may be solved for, and then the base luminance BY (BASE_Y) may be appropriately solved for on the basis of the minimum picture level (Min).

In this way, in the case where either the upper luminance slope (UPPER) or the base luminance BY (BASE_Y) is to be set to a fixed value, either the one-screen minimum picture level (Min) or the one-screen maximum picture level (Max) may be solved for in order to determine the other parameter that is not set to a fixed value.

In the foregoing embodiment described with reference to FIGS. 1 to 3, an LCD installed in an LCD panel 109 corresponds to the liquid crystal display element, while the functions of the backlight means are realized by a white LED and an LED drive installed in the LCD panel 109.

In addition, a luminance calculation circuit 105 realizes the functions of the average luminance calculating means, while a PWMGAIN calculation circuit 107 realizes the adjustment value calculating means. A PWM generation circuit 108 realizes the functions of the drive signal forming means.

In addition, the luminance calculation circuit 105 also realizes the functions of the luminance information detecting means, while an image correction circuit 104 realizes the functions of the image correcting means.

Meanwhile, in the foregoing modification described with reference to FIG. 4, an LCD installed in an LCD panel 209 corresponds to the liquid crystal display element, while the functions of the backlight means are realized by a white LED and an LED drive installed in the LCD panel 209.

In addition, a luminance calculation circuit 205 realizes the functions of the average luminance calculating means, while a luminance parameter inter-frame averaging circuit 210 realizes the functions of the average luminance averaging means, and a PWMGAIN calculation circuit 207 realizes the adjustment value calculating means. A PWM generation circuit 208 realizes the functions of the drive signal forming means.

In addition, the luminance calculation circuit 205 also realizes the functions of the luminance information detecting means, while the luminance parameter inter-frame averaging circuit 210 realizes the functions of the luminance information averaging means, and an image correction circuit 204 realizes the functions of the image correcting means.

(Application of Display Control Method)

The display apparatus 100 and 200 in accordance with the foregoing embodiments are subject to the application of a display control method in accordance with another embodiment of the present invention. In other words, the circuits in the display apparatus 100 shown in FIG. 1 respectively execute the following processing steps.

(1) The luminance calculation circuit 105 executes an average luminance calculating step, wherein the one-screen average picture level (i.e., the average luminance) is calculated for an image signal to be displayed.

(2) The PWMGAIN calculation circuit 107 executes an adjustment value calculating step, wherein an adjustment value for adjusting the level (i.e., the luminance) of the backlight means for the liquid crystal display element is calculated, on the basis of the one-screen average picture level calculated in the average luminance calculating step as well as a pre-determined linear luminance adjustment curve.

(3) The PWM generation circuit 108 executes a drive signal forming step, wherein a PWM signal (i.e., a drive signal) for causing the backlight of the LCD panel 109 to emit light is calculated on the basis of the adjustment value calculated in the adjustment value calculating step. The calculated PWM signal is then supplied to the LED drive of the LCD panel 109.

(4) The luminance calculation circuit 105 executes a luminance information detecting step, wherein the one-screen minimum picture level and maximum picture level (i.e., the minimum and maximum luminance) are detected for the image signal to be displayed.

(5) The image correction circuit 104 executes an image correcting step, wherein an amplification control is conducted with respect to the image signal to be processed on the basis of the adjustment value calculated in the adjustment calculating step, the average luminance calculated in the average luminance calculating step, the minimum luminance and the maximum luminance detected in the luminance information detecting step, as well as a pre-determined linear image luminance correction curve. The corrected image signal is then supplied to the liquid crystal display element.

A display control method that executes the above processing steps (1) to (5) is equivalent to the first display control method in accordance with an embodiment of the present invention.

Meanwhile, the circuits in the display apparatus 200 shown in FIG. 4 respectively execute the following processing steps.

(A) The luminance calculation circuit 205 executes an average luminance calculating step, wherein the one-screen average picture level (i.e., the average luminance) is calculated for an image signal to be displayed.

(B) The luminance parameter inter-frame averaging circuit 210 executes an average luminance averaging step, wherein the one-screen average picture level calculated in the average luminance calculating step is averaged over a plurality of frames.

(C) The PWMGAIN calculation circuit 207 executes an adjustment value calculating step, wherein an adjustment value for adjusting the level (i.e., the luminance) of the backlight means for the liquid crystal display element is calculated, on the basis of the average value of the average picture level calculated in the average luminance averaging step, as well as a pre-determined linear luminance adjustment curve.

(D) The PWM generation circuit 208 executes a drive signal forming step, wherein a PWM signal (i.e., a drive signal) for causing the backlight of the LCD panel 209 to emit light is calculated on the basis of the adjustment value calculated in the adjustment value calculating step. The calculated PWM signal is then supplied to the LED drive of the LCD panel 209.

(E) The luminance calculation circuit 205 executes a luminance information detecting step, wherein the one-screen minimum picture level and maximum picture level (i.e., the minimum and maximum luminance) are detected for the image signal to be displayed.

(F) The luminance parameter inter-frame averaging circuit 210 executes a luminance information averaging step, wherein the minimum luminance and the maximum luminance detected in the luminance information detecting step are respectively averaged over a plurality of frames.

(G) The image correction circuit 204 executes an image correcting step, wherein an amplification control is conducted with respect to the image signal to be processed on the basis of the adjustment value calculated in the adjustment calculating step, the average value of the average luminance calculated in the average luminance averaging step, the value of the minimum luminance and the value of maximum luminance respectively average over a plurality of frames in the luminance information averaging step, as well as a pre-determined linear image luminance correction curve. The corrected image signal is then supplied to the LCD of the LCD panel 209.

A display control method that executes the above processing steps (A) to (G) is equivalent to the second display control method in accordance with an embodiment of the present invention.

(Realization of Display Control Program)

It is also possible to apply a display control program in accordance with an embodiment of the present invention to the display apparatus 200 of the foregoing embodiment. In other words, in the display apparatus 200 shown in FIG. 4, the respective functions of the image correction circuit 204, the luminance calculation circuit 205, the parameter configuration register circuit 206, the PWMGAIN calculation circuit 207, and the luminance parameter inter-frame averaging circuit 210 may be realized by means of a program executed by the CPU 220.

More specifically, the respective processes conducted by the circuits of the display apparatus 200 may be realized by means of a program executed by the CPU 220 as follows. The program may be configured as a computer-readable program causing the CPU 220 of the display apparatus 200 to execute the following steps:

the average luminance calculating step (A) conducted by the luminance calculation circuit 205, wherein the one-screen average picture level (i.e., the average luminance) is calculated for an image signal to be displayed;

the average luminance averaging step (B) conducted by the luminance parameter inter-frame averaging circuit 210, wherein the one-screen average picture level calculated in the average luminance calculating step is averaged over a plurality of frames;

the adjustment value calculating step (C) conducted by the PWMGAIN calculation circuit 207, wherein an adjustment value for adjusting the level (i.e., the luminance) of the backlight for the LCD panel 209 is calculated on the basis of the average value of the average picture level calculated in the average luminance averaging step as well as a pre-determined linear luminance adjustment curve, and then the calculated adjustment value is supplied to drive signal forming means for forming a drive signal that causes the backlight to emit light;

the luminance information detecting step (E) conducted by the luminance calculation circuit 205, wherein the one-screen minimum picture level and maximum picture level (i.e., the minimum and maximum luminance) are detected for the image signal to be displayed;

the luminance information averaging step (F) conducted by the luminance parameter inter-frame averaging circuit 210, wherein the minimum luminance and the maximum luminance detected in the luminance information detecting step are respectively averaged over a plurality of frames; and

the image correcting step (G) conducted by the image correction circuit 204, wherein an amplification control is conducted with respect to the image signal to be processed on the basis of the adjustment value calculated in the adjustment calculating step, the average value of the average luminance calculated in the average luminance averaging step, the value of the minimum luminance and the value of the maximum luminance respectively averaged over a plurality of frames in the luminance information averaging step, as well as a pre-determined linear image luminance correction curve, and then the corrected image signal is supplied to the LCD of the LCD panel 209.

The program herein may be stored in memory such as ROM (Read-Only Memory) in the display apparatus 200 (not shown in the drawings), with the program being stored in a manner enabling execution by the CPU 220. The program may also be provided via various recording media, or electronically distributed via a network such as the Internet.

Furthermore, in the case of the display apparatus 100 shown in FIG. 1, the image correction circuit 104, the luminance calculation circuit 105, the parameter configuration register circuit 106, and the PWMGAIN calculation circuit 107 are provided after the LCDCTL 103. For this reason, if it is attempted to realize the above circuits by means of a program, control for coordinating operating with the LCDCTL 103 becomes difficult.

However, by appropriately controlling the LCDCTL 103 and the CPU 120, it is also possible to realize the respective functions of the image correction circuit 104, the luminance calculation circuit 105, the parameter configuration register circuit 106, and the PWMGAIN calculation circuit 107 by means of a program.

In the above programs, the functions of the PWM generation circuits 108 and 208 are not included therein. However, the present invention is not limited to such programs. If the processing capability of the CPU is high, then the functions of the PWM generation circuits 108 and 208 may also be realized by means of a program. It is of course also possible to use a plurality of CPUs to distribute the above processing.

(Other)

The foregoing describes, by way of example, the case wherein an embodiment of the present invention is applied to a display apparatus installed in a mobile phone handset. However, the present invention is not limited to such configurations. In addition to mobile phone handsets, an embodiment of the present invention may also be applied to display apparatus installed in a variety of portable electronic devices, such as personal, portable handsets or electronic address books referred to as PDAs (Personal Digital Assistants), or laptop computers, for example.

More particularly, in recent years, one segment reception services (often referred to as 1 seg broadcasts) geared for mobile phones and other mobile devices are being offered. The present invention is ideal when applied to portable devices able to receive and make use of terrestrial digital television broadcasts designed for reception by such mobile phones or similar portable devices.

Moreover, an embodiment of the present invention may also of course be used in a display apparatus mounted in an electronic device that is installed and used in the home or similar locations.

The present application contains subject matter related to that disclosed in Japanese Priority Patent Application JP 2008-130437 filed in the Japan Patent Office on May 19, 2008, and Japanese Priority Patent Application JP 2008-206683 filed in the Japan Patent Office on Aug. 11, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display apparatus, comprising:
a liquid crystal display element;
backlight means for use with the liquid crystal display element;
average luminance calculating means for calculating the one-screen average luminance of an image expressed by an image signal for display;
adjustment value calculating means for calculating an adjustment value used to adjust the luminance of the backlight means on the basis of the one-screen average image luminance from the average luminance calculating means, as well as a predetermined linear luminance adjustment curve;
drive signal forming means for forming a drive signal used to cause the backlight means to emit light on the basis of the adjustment value calculated by the adjustment value calculating means, and then providing the resulting drive signal to the backlight means;
luminance information detecting means for detecting one or both of the one-screen minimum image luminance and the one-screen maximum image luminance expressed by the image signal for display; and
image correcting means for conducting an amplification control with respect to the image signal for display on the basis of a linear image luminance correction curve specified by the adjustment value calculated by the adjustment value calculating means, the average luminance calculated by the average luminance calculating means, and one or both of the minimum luminance and the maximum luminance detected by the luminance information detecting means, and then providing the corrected image signal to the liquid crystal display element.

2. A display apparatus, comprising:
a liquid crystal display element;
backlight means for use with the liquid crystal display element;
average luminance calculating means for calculating the one-screen average luminance of an image expressed by an image signal for display;
average luminance averaging means for calculating the average value of the one-screen average luminance from the average luminance calculating means over a plurality of screens;
adjustment value calculating means for calculating an adjustment value used to adjust the luminance of the backlight means on the basis of the average value of the average luminance from the average luminance averaging means and a predetermined linear luminance adjustment curve;
drive signal forming means for forming a drive signal used to cause the backlight means to emit light on the basis of the adjustment value calculated by the adjustment value calculating means, and then providing the resulting drive signal to the backlight means;
luminance information detecting means for detecting one or both of the one-screen minimum image luminance and the one-screen maximum image luminance expressed by the image signal for display;
luminance information averaging means for calculating one or both of the average value of the minimum luminance detected by the luminance information detecting means over a plurality of screens, and the average value of the maximum luminance detected by the luminance information detecting means over a plurality of screens; and
image correcting means for conducting an amplification control with respect to the image signal for display on the basis of a linear image luminance correction curve specified by the adjustment value calculated by the adjustment value calculating means, the average value of the average luminance calculated by the average luminance averaging means, and one or both of the average minimum luminance over a plurality of screens and the average maximum luminance over plurality of screen calculated by the luminance information averaging means, and then providing the corrected image signal to the liquid crystal display element.

3. The display apparatus according to claim 1 or 2, wherein the linear luminance adjustment curve used by the adjustment value calculating means is specified on the basis of a minimum and a maximum value for the backlight luminance adjustment value, one or more threshold values for the average luminance, and a plurality of linear luminance adjustment curve slopes defined for each subset in the domain of average luminance values divided by the one or more average luminance threshold values.

4. The display apparatus according to claim 1 or 2, wherein the linear luminance adjustment curve used by the adjustment value calculating means is specified on the basis of a minimum and a maximum value for the backlight luminance adjustment value, a first threshold value on the lower side of the domain of average luminance values, a second threshold value on the higher side of the domain of average luminance values, and a linear luminance adjustment curve slope defined for each of the three subsets in the domain of average luminance values divided by the first and second threshold values.

5. The display apparatus according to claim 4, wherein
the slope of the linear luminance adjustment curve in the region where the average luminance exists between the first threshold value and the second threshold value is proportional to change in the average luminance, and
the slopes of the linear luminance adjustment curve in the region below the first threshold value and the region above second threshold value are less than or equal to change in the average luminance.

6. The display apparatus according to claim 1 or 2, wherein the linear image luminance correction curve used by the image correcting means is specified on the basis of a first slope for a lower subset of luminance values in the image signal being processed, a second slope for a higher subset of luminance values in the image signal being processed, a base luminance value defining the lowest luminance value for the corrected image signal in the case where the luminance of the image signal being processed is zero, and an inflection point indicating the luminance value at which the slope changes.

7. The display apparatus according to claim 6, wherein
the first slope is proportional to change in the luminance of the image signal being processed, and
the second slope has a value less than or equal to 1.

8. A display control method, comprising the steps of:
calculating the one-screen average luminance of an image expressed by an image signal for display;
calculating an adjustment value used to adjust the luminance of backlight means for a liquid crystal display element on the basis of the one-screen average image luminance calculated in the average luminance calculating step and a predetermined linear luminance adjustment curve;
forming a drive signal used to cause the backlight means to emit light on the basis of the adjustment value calculated in the adjustment value calculating step, and then providing the resulting drive signal to the backlight means;
detecting one or both of the one-screen minimum image luminance and the one-screen maximum image luminance expressed by the image signal for display; and
conducting an amplification control with respect to the image signal for display on the basis of a linear image luminance correction curve specified by the adjustment value calculated in the adjustment value calculating step, the average luminance calculated in the average luminance calculating step, and one or both of the minimum luminance and the maximum luminance detected in the luminance information detecting step, and then providing the corrected image signal to the liquid crystal display element.

9. A display control method, comprising the steps of:
calculating the one-screen average luminance of an image expressed by an image signal for display;
averaging the one-screen average luminance calculated in the average luminance calculating step over a plurality of screens;
calculating an adjustment value used to adjust the luminance of backlight means for a liquid crystal display element on the basis of the average value of the average luminance calculated in the average luminance averaging step and a predetermined linear luminance adjustment curve;
forming a drive signal used to cause the backlight means to emit light on the basis of the adjustment value calculated in the adjustment value calculating step, and then providing the resulting drive signal to the backlight means;
detecting one or both of the one-screen minimum image luminance and the one-screen maximum image luminance expressed by the image signal for display;
respectively averaging one or both of the minimum luminance and the maximum luminance detected in the luminance information detecting step over a plurality of screens; and
conducting an amplification control with respect to the image signal for display on the basis of a linear image luminance correction curve specified by the adjustment value calculated in the adjustment value calculating step, the average value of the average luminance calculated in the average luminance averaging step, and one or both of the average minimum luminance over a plurality of screens and the average maximum luminance over a plurality of screens calculated in the luminance information averaging step, and then providing the corrected image signal to the liquid crystal display element.

10. A computer-readable display control program that causes a computer installed in a display apparatus to execute the steps of:
calculating the one-screen average luminance of an image expressed by an image signal for display;
calculating an adjustment value used to adjust the luminance of backlight means for a liquid crystal display element on the basis of the one-screen average image luminance calculated in the average luminance calculating step and a predetermined linear luminance adjustment curve, and then supplying the adjustment value to drive signal forming means for forming a drive signal that causes the backlight means to emit light;
detecting one or both of the one-screen minimum image luminance and the one-screen maximum image luminance expressed by the image signal for display; and
conducting an amplification control with respect to the image signal for display on the basis of a linear image luminance correction curve specified by the adjustment value calculated in the adjustment value calculating step, the average luminance calculated in the average luminance calculating step, and one or both of the minimum luminance and the maximum luminance detected in the luminance information detecting step, and then providing the corrected image signal to the liquid crystal display element.

11. A computer-readable display control program that causes a computer installed in a display apparatus to execute the steps of:
calculating the one-screen average luminance of an image expressed by an image signal for display;
averaging the one-screen average luminance calculated in the average luminance calculating step over a plurality of screens;
calculating an adjustment value used to adjust the luminance of backlight means for a liquid crystal display element on the basis of the average value of the average luminance calculated in the average luminance averaging step and a predetermined linear luminance adjustment curve, and then supplying the adjustment value to drive signal forming means for forming a drive signal that causes the backlight means to emit light;
detecting one or both of the one-screen minimum image luminance and the one-screen maximum image luminance expressed by the image signal for display;
respectively averaging one or both of the minimum luminance and the maximum luminance detected in the luminance information detecting step over a plurality of screens; and
conducting an amplification control with respect to the image signal for display on the basis of a linear image luminance correction curve specified by the adjustment value calculated in the adjustment value calculating step, the average value of the average luminance calculated in the average luminance averaging step, and one or both of the average minimum luminance over a plurality of screens and the average maximum luminance over a plurality of screens calculated in the luminance information averaging step, and then providing the corrected image signal to the liquid crystal display element.

12. A display apparatus, comprising:
a liquid crystal display element;
a backlight for use with the liquid crystal display element;
an average luminance calculation circuit configured to calculate the one-screen average luminance of an image expressed by an image signal for display;
an adjustment value calculation circuit configured to calculate an adjustment value used to adjust the luminance of the backlight on the basis of the one-screen average image luminance from the average luminance calculation circuit and a predetermined linear luminance adjustment curve;
a drive signal generation circuit configured to form a drive signal used to cause the backlight to emit light on the basis of the adjustment value calculated by the adjustment value calculation circuit, and then providing the resulting drive signal to the backlight;
a luminance information detection circuit configured to detect one or both of the one-screen minimum image luminance and the one-screen maximum image luminance expressed by the image signal for display; and
an image correction circuit configured to conduct an amplification control with respect to the image signal for display on the basis of a linear image luminance correction curve specified by the adjustment value calculated by the adjustment value calculation circuit, the average luminance calculated by the average luminance calculation circuit, and one or both of the minimum luminance and the maximum luminance detected by the luminance information detection circuit, and then providing the corrected image signal to the liquid crystal display element.

13. A display apparatus, comprising:
a liquid crystal display element;
backlight for use with the liquid crystal display element;
an average luminance calculation circuit configured to calculate the one-screen average luminance of an image expressed by an image signal for display;
an average luminance averaging circuit configured to calculate the average value of the one-screen average luminance from the average luminance calculation circuit over a plurality of screens;
an adjustment value calculation circuit configured to calculate an adjustment value used to adjust the luminance of the backlight on the basis of the average value of the average luminance from the average luminance averaging circuit and a predetermined linear luminance adjustment curve;
a drive signal generation circuit configured to form a drive signal used to cause the backlight to emit light on the basis of the adjustment value calculated by the adjustment value calculation circuit, and then providing the resulting drive signal to the backlight;
a luminance information detection circuit configured to detect one or both of the one-screen minimum image luminance and the one-screen maximum image luminance expressed by the image signal for display;
a luminance information averaging circuit configured to calculate one or both of the average value of the minimum luminance detected by the luminance information detection circuit over a plurality of screens, and the average value of the maximum luminance detected by the luminance information detection circuit over a plurality of screens; and
an image correction circuit configured to conduct an amplification control with respect to the image signal for display on the basis of a linear image luminance correction curve specified by the adjustment value calculated by the adjustment value calculation circuit, the average value of the average luminance calculated by the average luminance averaging circuit, and one or both of the average minimum luminance over a plurality of screens and the average maximum luminance over plurality of screen calculated by the luminance information averaging circuit, and then providing the corrected image signal to the liquid crystal display element.
